(19) United States
(12) Patent Application Publication
(10) Pub. No.: US 2004/0134438 A1
(43) Pub. Date: Jul. 15, 2004

(54) Pet food dispensers and methods of dispensing pet food

(76) Inventor: Richard Ticktin, Fort Lauderdale, FL (US)

Correspondence Address: BOZICEVIC, FIELD & FRANCIS LLP, 200 MIDDLEFIELD RD, SUITE 200, MENLO PARK, CA, 94025, US

(21) Appl. No.: 10/685,756

(22) Filed: Oct. 14, 2003

Related U.S. Application Data
(60) Provisional application No. 60/417,929, filed on Oct. 11, 2002.

(51) Int. Cl. A01K 1/10

(52) U.S. Cl. 119/65

(57) ABSTRACT

The subject invention provides pet food dispensers. Embodiments of the subject pet food dispensers include a housing and a resealable opening therein. The housing is configured for retaining and controllably dispensing a selected amount of flowable pet food through the resealable opening. Also provided is packaged pet food. Embodiments of the packaged pet food include a subject pet food dispenser and ambient temperature stable flowable pet food retained therein. In certain embodiments, the subject dispensers are pre-filled with multiple servings of pet food, e.g., multiple servings of ambient temperature stable flowable pet food.

Also provided are methods of retaining and dispensing flowable pet food. Embodiments of the subject methods include applying light to moderate pressure to the exterior of a pet food dispenser having flowable pet food retained therein to controllably dispense a selected amount of said pet food from a resealable opening of said pet food dispenser.

### CROSS REFERENCE TO RELATED APPLICATIONS

The present application claims priority under 35 U.S.C. § 119(e) to U.S. provisional application No. 60/417,929 filed Oct. 11, 2002, the disclosure of which is incorporated herein by reference in its entirety.

### FIELD OF THE INVENTION

The field of this invention is pet food dispensers and methods of containing and dispensing pet food.

### BACKGROUND OF THE INVENTION

Pet food is available in a wide variety of forms, including dry food forms such as cereals (commonly referred to as kibble) and wet food forms or rather pet food that has a moisture content sufficient to provide pet food that is wet or moist. Because wet food is moist, it may also be characterized as flowable pet food due to its viscosity.

Heretofore. A wide variety of methods have been proposed for packaging and/or dispensing pet or animal foods. Typically, foods (such as dry foods) such as those for cats, dogs and other small pets are packaged by the producer in boxes or bags. A pet owner will dispense the food into a dish or bowl each time the pet is fed. Feeding the pet, therefore, becomes a daily chore.

Attempts have been made to provide pet food feeders that store an extended supply of food and dispense the food into a tray upon demand. Such feeders eliminate the daily feeding chore. Such devices typically include a food container and tray. If the container is made separable from the tray to facilitate filling, provision must be made to interconnect the container and tray to avoid inadvertent spilling. The attachment method must be sufficiently secure to prevent the pet from separating the container and tray while still permitting easy separation by the pet owner.

An example of one such pet food dispenser may be found in commonly owned U.S. Pat. No. 4,034,715 entitled Convertible Pet Feeder and Method and issued on Jul. 12, 1977 to Amer. The feeder disclosed therein includes a separable feeding tray and a container. The container is adaptable to hold and deliver dry pet foods or liquids. An example of another such device may be found in U.S. Pat. No. 4,840,143 entitled Pet Food Dispenser and issued on Jun. 20, 1989 to Simon.

Wet or flowable pet food is often packaged in a can having a non-resealable lid.

Accordingly, to remove a desired amount of flowable pet food from these pet food cans, the lid must be opened (e.g., with a can opener or by pulling on a tab in the case of pull-top cans) and discarded and a utensil such as a spoon or fork must be used to remove some or all of the contents of the can for serving to a pet.

This type and analogous types of pet food packaging have some significant disadvantages. For example, the lid of a can has sharp edges which can be dangerous. Also, if some of the pet food remains for use at a later time, it must be refrigerated to avoid spoilage. However, refrigerating pet food may cause loss of water and thus drying-out of the pet food. Furthermore, flowable pet food often has unpleasant odors which may permeate human food product present in the refrigerator, thereby making the human food unpleasant to smell and/or taste. Still further, undesirable confusion between food for humans and animals and may occur when pet food is refrigerated with human food.

Prior to refrigeration, the pet food can is typically covered in an attempt to minimize drying-out or rather evaporation of water from the remaining pet food and also to minimize contamination of human food products in the refrigerator. Coverings for opened pet food cans that are often used include plastic wrap (e.g., SaranWrap) and aluminum foil, as well as plastic lids specially designed for covering pet food cans (e.g., U.S. Pat. No. 5,695,208). However, these coverings are not entirely satisfactory as odors may still permeate through and/or around the covering and the pet food may still dry-out.

Furthermore, as noted above, a separate utensil, oftentimes one that is also used for human food, must be used to remove a portion of the food from the can. If not immediately washed, residual pet food adherent to the utensil turns to a hard crust on the utensil which may be hard to remove without detergents and scrubbing.

As such, there continues to be an interest in the development of new pet food dispensers for dispensing flowable pet food. The dispensing devices or feeders heretofore provided have been sold separately from the pet or animal food. The pet owner is required to fill the food supply container each time the device is used. A need exists for a pet food dispenser and packaging system that may be filled by the food producer and purchased by the pet owner. A need exists for a pet food dispenser that is easily useable, relatively inexpensively manufactured and which is reliable in use. Of particular interest are pet food dispensers that are easy to use and do not require a separate component such as a utensil, to remove a controllable amount of flowable pet food from the dispenser. Also of interest are packaged pet food products that include flowable pet food that is shelf-stable at ambient temperatures after initial opening by a user and thus do not require refrigeration after opening.

### SUMMARY OF THE INVENTION

The subject invention provides pet food dispensers. Embodiments of the subject pet food dispensers include a housing and a resealable opening therein. The housing is configured for retaining and controllably dispensing a selected amount of flowable pet food through the resealable opening. Also provided is packaged pet food. Embodiments of the packaged pet food include a subject pet food dispenser and ambient temperature stable flowable pet food retained therein. In certain embodiments, the subject dispensers are pre-filled with multiple servings of pet food, e.g., multiple servings of ambient temperature stable flowable pet food.

The subject invention also provides methods of retaining and dispensing flowable pet food. Embodiments of the subject methods include applying light to moderate pressure to the exterior of a pet food dispenser having flowable pet food retained therein to controllably dispense a selected amount of said flowable pet food from a resealable opening of said pet food dispenser.

Embodiments of the present invention eliminate the above-mentioned needs for a pet food dispenser and packaging system that may be filled by the pet food producer and purchased by the pet owner by providing a flexible, squeezable pet food dispenser and method of utilizing the same.

In accordance with embodiments of the present invention, there is provided a pet food dispenser including a flexible food container having joined walls and defining a food discharge opening, and a releasable, resealable closure on the flexible food container for opening and closing the food discharge opening, the releasable, resealable closure indicating a base member and a cap member, wherein the base member operatively engages the closure attachment region and wherein the cap member seals said discharge opening and permits the container to be used for shipping, storing, selling and dispensing of pet food.

Embodiments of the present invention are additionally directed to a method for providing a food product to a recipient, the method including the steps of filling a flexible food container with a predetermined amount of the food product, and releasably sealing the flexible food container with a releasable, resealable closure, wherein the releasable, resealable closure inhibits spoilage of the food product and permits the container to be used for shipping, storing, selling and dispensing of pet food.

### BRIEF DESCRIPTIONS OF THE DRAWINGS

FIGS. 1A-1D illustrate an exemplary embodiment of a pet food dispenser of the present invention.

FIGS. 2A-2C illustrate another exemplary embodiment of a pet food dispenser of the present invention.

FIGS. 3A-3D illustrate another exemplary embodiment of a pet food dispenser of the present invention.

FIGS. 4A-4B illustrate another exemplary embodiment of a pet food dispenser of the present invention.

FIG. 5 illustrates an exemplary embodiment of a resealable closure that may be employed with a subject pet food dispenser.

FIG. 6 illustrates another exemplary embodiment of a resealable closure that may be employed with a subject pet food dispenser.

### DETAILED DESCRIPTION OF THE INVENTION

The subject invention provides pet food dispensers. Embodiments of the subject pet food dispensers include a housing and a resealable opening therein. The housing is configured for retaining and controllably dispensing a selected amount of flowable pet food through the resealable opening. Also provided is packaged pet food. Embodiments of the packaged pet food include a subject pet food dispenser and ambient temperature stable flowable pet food retained therein. In certain embodiments, the subject dispensers are pre-filled with multiple servings of pet food, e.g., multiple servings of ambient temperature stable flowable pet food.

The subject invention also provides methods of retaining and dispensing flowable pet food. Embodiments of the subject methods include applying light to moderate pressure to the exterior of a pet food dispenser having flowable pet food retained therein to controllably dispense a selected amount of said flowable pet food from a resealable opening of said pet food dispenser.

Before the present invention is described, it is to be understood that this invention is not limited to particular embodiments described, as such may, of course, vary. It is also to be understood that the terminology used herein is for the purpose of describing particular embodiments only, and is not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range is encompassed within the invention. The upper and lower limits of these smaller ranges may independently be included in the smaller ranges is also encompassed within the invention, subject to any specifically excluded limit in the stated range. Where the stated range includes one or both of the limits, ranges excluding either or both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, the preferred methods and materials are now described. All publications mentioned herein are incorporated herein by reference to disclose and describe the methods and/or materials in connection with which the publications are cited.

Although only a few exemplary embodiments of the present invention have been described in detail above, those skilled in the art will readily appreciate that numerous modifications to the exemplary embodiments are possible without materially departing from the novel teachings and advantages of this invention. Accordingly, all such modifications are intended to be included within the scope of this invention as defined in the following numbered paragraphs and accompanying drawings.

It must be noted that as used herein and in the appended claims, the singular forms “a”, “an”, and “the” include plural referents unless the context clearly dictates otherwise.

The publications discussed herein are provided solely for their disclosure prior to the filing date of the present application. Nothing herein is to be construed as an admission that the present invention is not entitled to antedate such publication by virtue of prior invention. Further, the dates of publication provided may be different from the actual publication dates which may need to be independently confirmed.

As will be apparent to those of skill in the art upon reading this disclosure, each of the individual embodiments described and illustrated herein has discrete components and features which may be readily separated from or combined with the component and features of any of the other several embodiments without departing from the scope or spirit of the present invention.

The figures shown herein are not necessarily drawn to scale, with some components and features being exaggerated for clarity.

As summarized above, embodiments of the subject invention provide resealable pet food dispensers for controllably dispensing a selected amount of flowable pet food from a resealable opening in the dispenser and methods of dispensing a controllable amount of flowable pet food from a pet food dispenser. In further describing the subject invention, embodiments of the subject pet food dispensers are described first in greater detail, followed by exemplary embodiments of pet food compositions that may be used with the subject dispensers. Finally, a review of methods of controllably dispensing pet food is provided.

Resealable Pet Food Dispensers

As noted above, the subject invention provides pet food dispensers. In general, the subject dispensers are resealable pet food dispensers that are configured to dispense a controllable amount of pet food therefrom. By “resealable” it is meant that the dispensers may be repeatedly opened and closed by actuating, e.g., attaching/detaching, a component of the dispenser itself. As described in the Background section, pet food is often available in a can. Once opened, pet food remaining in the can is often covered by extraneous components such as SaranWrap, foil or other pet food closure devices (e.g., U.S. Pat. No. 5,695,208). However, these cans and analogous pet food containers are not considered to be resealable as, after being opened, the coverings that are used to cover them are not part of the pet food container itself.

The dispensers of the subject invention may be used to controllably dispense a selected amount of a wide variety of pet foods. The dispensers of the subject invention are particularly well suited to dispense flowable pet food. By “flowable pet food” it is meant that the pet food is in a flowable form. Accordingly, the subject dispensers are configured to dispense pet foods that include an amount of water sufficient to enable the pet food to be flowable. In other words, flowable pet food may be described as pet food that has a viscosity sufficient to enable the pet food to flow-unlike a dry type pet food. Flowable pet foods may be in a variety of different forms, e.g., pastes, gels, pates, and the like, which may or may not include solids.

The amount of water present in flowable pet food is usually at least about 40% to about 85%. Accordingly, the viscosity of flowable pet food may range from about 80,000 cPs to about 1,000,000 cPs. Embodiments include flowable pet food that has water activity (a_{w}) that ranges from about 0.8 to about 0.95.

Embodiments of the subject dispensers include a housing that has a resealable opening therein. The shapes of the housings may vary and may range from simple to complex, with the only limitation that they are suitably configured to retain at least one serving and in many embodiments are configured to retain multiple servings, of pet food. Typically, the housings are shaped so as to be easily handled and managed by a user. Embodiments include regularly shaped housings such as rounded (e.g., circular, elliptical, ovolaid, oblong, and the like), rectilinear (e.g., square, rectangular, and the like), frustrum, etc., shaped housings, although other shapes are possible as well, such as irregular or complex shapes.

Similarly, the size of the housing may vary depending on a variety of factors, including, but not limited to, the particular pet food retained therein, the particular amount of pet food retained therein, etc. In many embodiments, the housings of the subject dispensers are of sufficient size and volume to retain at least one serving of pet food and in many embodiment are of sufficient size and volume to retain a plurality of servings of pet food. Accordingly, the housing may be available in a wide variety of sizes and volumes. Embodiments include dispensers that are sized to be easily transportable or moveable, e.g., for feeding household pets such as cats, dogs, fish, etc. For example, embodiments may have lengths that range from about 4 inches to about 12 inches or more, widths that range from about 2 inches to about 12 inches or more. (Circular shaped dispensers may have analogous dimensions.) In certain embodiments, it may be necessary to apply a light to moderate pressure to one or more walls of the housing to deform them to eject a controllable amount of pet food. Accordingly, embodiments include housings having at least one wall of suitable thickness. For example, wall thicknesses may range from about 4 mils to about 30 mils.

The interior volume of the space bound by the housing, i.e., the housing volume, may range from about 50 milliliters to about 2000 milliliters or more, e.g., from about 80 milliliters to about 1500 milliliters, e.g., from about 85 milliliters to about 1200 milliliters. Embodiments also include housings that have constant cross sectional areas along the entire length of the housing (i.e., the cross sectional dimension may not change substantially) such that the cross sectional area of a given housing from a first end to a second end does not substantially vary. Embodiments also include variable or non-constant cross sectional areas along the entire length of the housing (i.e., the cross sectional dimension may change) such that the cross sectional area of a given housing from a first end to a second end may vary or rather may differ.

As noted above, the subject dispensers may be configured to retain a plurality of servings of flowable pet food for household pets, e.g., cats, such that a dispenser may be unsealed, a first serving controllably dispensed and the dispenser may be resealed with additional servings sealed therein for dispensing at a later time. The number of servings retained in a subject dispenser may vary depending on the particular pet food retained, etc., where the number of pet food servings retained by the subject dispensers may range from about 1 to about 30 or more, e.g., from about 1 to about 20, e.g., from about 1 to about 14, e.g., from about 1 to about 7. Because the subject dispensers are resealable, they are particularly well suited to retain a plurality of pet food servings. For example, embodiments include pet food dispensers configured to retain a plurality of servings of flowable cat food. In such embodiments, the number of total cat food servings retained in the housings may fall within the ranges described above and the total amount of flowable cat food retained in such embodiments may range from about 3 ounces to about 100 ounces, e.g., from about 3 ounces to about 70 ounces, such that individual servings ranging from about 3 ounces to about 5 ounces may be expelled from the pet food dispenser one at a time in a controllable manner.

The housings of the subject pet food dispensers may be manufactured from a variety of materials, with the only limitation being that the materials used to fabricate the subject devices are not harmful to pet food retained therein. For example, embodiments include materials that are substantially chemically inert, physically stable, thermally stable, durable, and relatively light weight, etc. Materials for the housing are those that meet U.S. Food and Drug Administration requirements for pet food packaging. Examples of materials that may be used in the fabrication of the subject pet food dispensers include, but are not limited to, metals and metal alloys such as aluminum and alloys thereof, steel and alloys thereof, plastics such as polypropylene, polyethylenes including high density polyethylene (HDPE), low density polyethylene (LDPE), and linear low density polyethylenes (LLDPE), polystyrene including high impact polystyrene, polytetrafluoro-ethylene, polypropylene, poly (4-methylbutene), polystyrene, poly(ethylene terephthalate), polyolefin, polycarbonate, polyacrylamide, polyacrylate, polymethacrylate, polyesters, PVC and blends thereof, and other polymers or elastomers, e.g., flexible polymers or elastomers, e.g., nylon and the like. Paperboard, including laminated paperboards, may also be employed in the manufacture of the subject dispensers.

The housings may be fabricated from a single material, or be a composite of two or more different materials. For example, the particulates may be fabricated from a “composite,” i.e., a composition made up of different or unlike materials. The composite may be a block composite, e.g., an A-B-A block composite, an A-B-C block composite, or the like. Alternatively, the composite may be a heterogeneous combination of materials, i.e., in which the materials are distinct from separate phases, or a homogeneous combination of different or unlike materials. As used herein, the term “composite” is used to include a “laminate” composite. A “laminate” refers to a composite material formed from several different bonded layers of identical or different materials.

Embodiments include housings that are flexible and resilient. More specifically, in certain embodiments a given housing or a portion thereof may be flexible such that it is capable of being bent, folded or similarly manipulated, e.g., squeezed, e.g., to the degree of usage of the dispenser, without breakage. For example, depending on the viscosity of the flowable pet food retained in a dispenser, application of a light to moderate pressure may be required to resiliently deform one or more walls of the housing to controllably squeeze a desired amount of pet food from the container, in which cases housings must be deformable. However, in embodiments where the pet food is in a highly liquid form, e.g., having the viscosity at or about that of pure water at ambient temperature, application of pressure may not be needed. For example, at least a portion of the housing may be capable of being deformed by application of light to moderate pressure (e.g., hand pressure), i.e., deformably squeezed, and then may resiliently return to its original shape once the pressure is terminated. In other embodiments, at least a portion of the housing may be capable of being deformed by application of light to moderate pressure, i.e., deformably squeezed, and may not resiliently return to its original shape once the pressure is terminated.

Optional features of the subject housings, described in greater detail below, include gussets (e.g., a bottom gusset so that a housing may be capable of standing alone without any external support, bellows, and the like) and features that enable the dispensers to stand on end, e.g. in an upright position, without any external support.

As noted above, the subject pet food dispenser housing have a resealable opening therein that provides communication between the interior of the housing and the outside environment, i.e., provides a port, aperture or outlet through which flowable pet food retained in the housing may be controllably dispensed to the exterior of the housing for consumption by a pet. As such, the resealable openings of the housings may be characterized as resealable pet food discharge openings as it is through these openings that the pet food is controllably discharged from the housing.

The resealable opening may be positioned in any convenient location on the housing and the position will vary depending at least in part on the particular configuration of the housing with which it is associated. The size of the opening will also vary depending at least in part on the particular pet food dispensed therethrough and the typical serving size administered. For example, for housing having dimensions falling within the ranges provided above, openings are of sizes that are commensurate with those ranges and with efficient dispensation of pet food. Accordingly, embodiments include openings or orifices having dimensions, e.g., widths, that may range from about ¼ inch to about 1 inch, e.g., from about ¼ inch to about ½ inch in diameter. The openings may include cross- or star-shaped cuts such that flexible flaps may be provided over the opening such that pet food pushes against the flaps to move them into an outward direction as the pet food is passed therethrough. Such flaps may provide a barrier to contaminants, e.g., if the opening is inadvertently left unsealed after pet food is dispensed.

The opening may be opened/closed (i.e., adapted to be resealable) using any convenient resealable system. In general, the resealable opening is durable, long lasting and provides a reliable pet food impermeable seal when in a closed position. The seal about the opening may be accomplished by a component integral with the housing, e.g., integrally formed with the housing or otherwise physically, chemically or mechanically attached to the housing and/or opening or may be a completely separable component. Embodiments of such integral components include resealable openings that include, but are not limited to, twist caps, pull caps, snap caps, flip top closures, push-pull base orifices, friction-fit removal cap, yorker spout caps, stoppers, plugs, press-to-seal and push-to-open closures, and the like. For example, embodiments may include a valve seal (i.e., a sealing devise which seals on the inside of the neck finish of the housing in the fashion of a plug). Embodiments may also include non-threaded closures (i.e., closures which do not require threading action to seal/unseal the opening, e.g., snap caps, sifter fitments, pour-out fitments, etc.). Embodiments may also include threaded closures (i.e., closures which require threading action to seal/unseal the opening). Closures may be made of the same material as the housing. For example, a closure may be a plastic, metal, etc., or combination of like or unlike materials. Accordingly, embodiments of the closures are capable of going or rather moving or being manipulated or directed (e.g., translated or otherwise actuated) from a first position that operatively seals or covers (i.e., closes) the opening of the housing to a second position that operatively unseals or uncovers (i.e., opens) the opening such that the opening in opened to the environment. As such closures of the subject invention may be characterized as releasable in that they may be readily released from a first position to a second position, and vice versa. Analogously, they may also be characterized as resealable closures. In many embodiments, positioning a closure from a first closed position to a second unclosed position is accomplished in a single step, e.g., a single fluid motion.

Optional features may include internal sealing rings, liners, sealing ledges, ribs, threads, means to attach a closure component to the dispenser such as a hinge, etc. Embodiments may also include a tamper-evident feature so that a user can verify that the resealable opening has not been tampered with or breached prior to first use. Any convenient tamper-evident feature or seal may be employed, including, but not limited to tamper-evident films or coverings such as (e.g., vinyl, acetate, aluminum, etc.), shrink bands, mechanical breakaway bands (i.e., a closure with a portion or section of the skirt perforated or weakened in some manner so when the closure is opened, the section is designed to break apart and either remain on the container or attach to the closure to indicate the package has been opened), and the like.

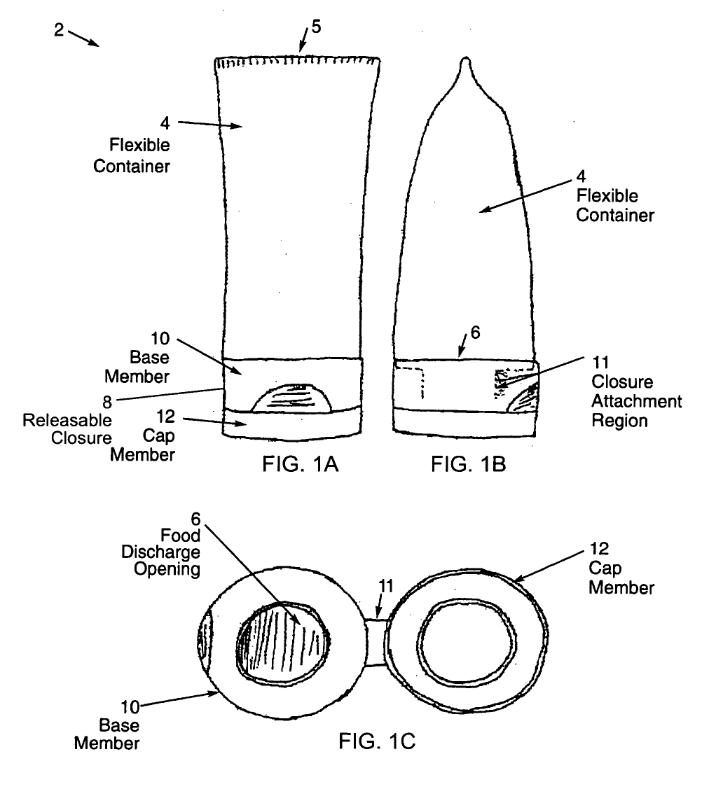

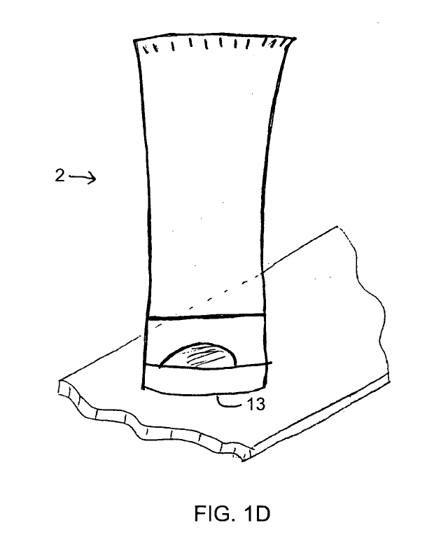

Embodiments of the subject invention (for example, embodiments including, but not limited to, those shown and described in FIGS. 1A-1D) may be described as pet food dispensers having joined walls and defining a food discharge opening, a closure attachment region (see for example closure attachment region 11 of FIG. 1B) surrounding the food discharge opening, and a releasable closure on the flexible food container for opening the food discharge opening, the releasable closure including a base member and a cap member, wherein the base member operatively engages the closure attachment region and wherein the cap member seals the discharge opening and permits the container to be used for shipping, storing, selling and dispensing of pet food.

FIGS. 1A (front view), 1B (side view) and 1C (top down view) show an exemplary embodiment of a resealable flowable pet food dispenser 2 according to the subject invention such that it is configured for controllable dispensation of a desired amount of pet food. Dispenser 2 includes housing 4 which may be fabricated from a single piece or sheet of material or may be two or more pieces or sheets joined or bonded together. In any event, the material of the housing may be attached or joined together at appropriate locations to provide a pet food tight seal using any convenient technique (e.g., joining two or more edges of a single piece of material or two or more edges of multiple pieces of material). For example, housing 4 may be formed by joining edges of a single piece, sheet or panel of material together and/or by joining edges of multiple pieces, sheets or panels of material together, e.g., along edge 5 of FIG. 1A. Joining of material together may be accomplished by heat sealing or welding the material together to form a substantially airtight seal. Typical heated elements, ultrasonic, friction or chemical welding may be employed for welding. Alternately, desired sealing may be accomplished using silicone gel, adhesives or otherwise. The same joining methods may be used in any variation of the housing.

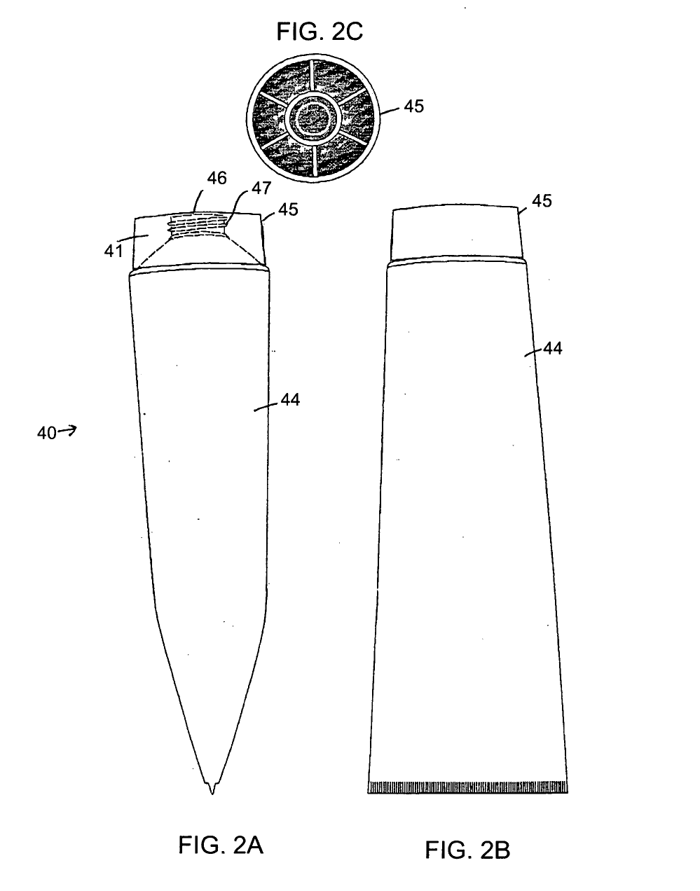

As shown, housing 4 includes closure member 8 about resealable opening 6. Closure 8 includes base member 10 and cap member 12 (shown in this embodiments as a snap cap member, i.e., operatively snaps onto base member 10, however other cap member configurations are contemplated as well such as screw caps, plugs, etc.) connected via optional hinge member 11, to base 10, as shown in FIG. 2. Accordingly, closure 8 enables opening 6 to be repeatedly sealed and unsealed to dispense pet food from the dispenser. A further advantage of closure 8 is that it provides a surface 13 of closure 8 upon which the dispenser can stand on end, i.e., stand in an upright position, without any external support as shown in FIG. 1D. Accordingly, when positioned in an upright position on closure 8, gravitational forces may position and maintain pet food retained in the housing towards the dispensing end, and more specifically near the resealable opening, for priming the pet food for ready dispensing.

FIGS. 2A, 2B and 2C show another exemplary embodiment of a pet food dispenser 40 according to the subject invention such that it is configured for controllable dispensation of a desired amount of pet food. Dispenser 40 is analogous to dispenser 20, however dispenser 40 includes a screw cap closure system. Specifically, dispenser 40 includes flexible housing 44 and closure attachment region 41. Housing 44 includes resealable opening 46. Threads are provided about opening 46. Screw cap 45, shown separated from the housing in FIG. 2B and shown sealably attached to housing 44 in FIG. 2B, enables opening 46 to be repeatedly sealed and unsealed to dispense pet food from the dispenser, i.e., is adapted to seal or rather re-seal opening 46 after dispensation of pet food from the dispenser.

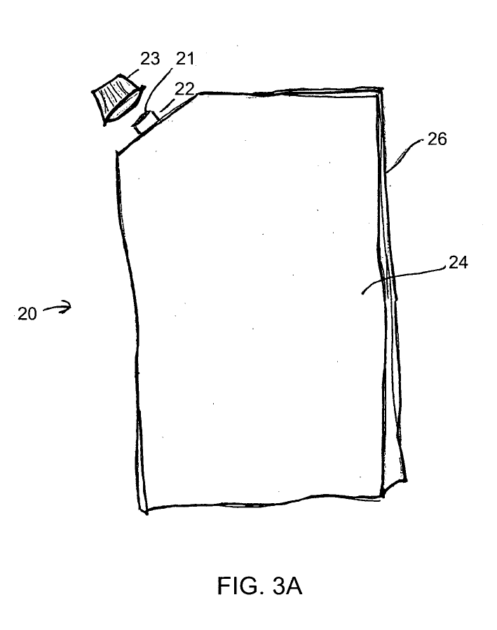

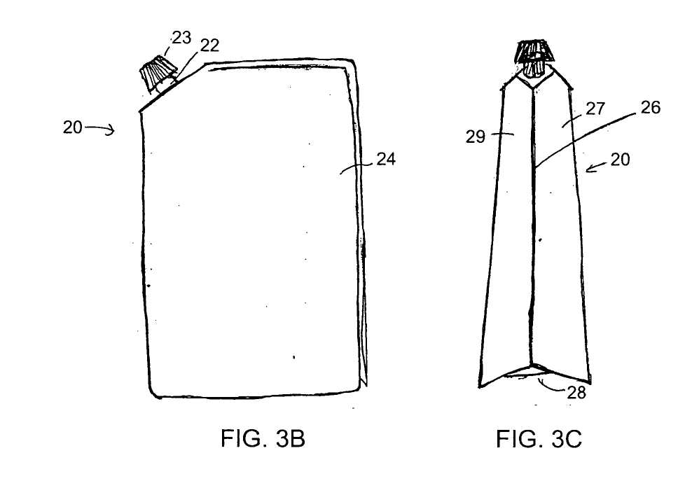

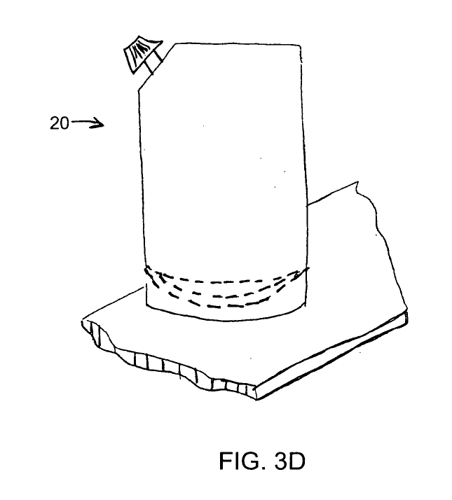

FIGS. 3A and 3B (front view) and 3c (side view) show another exemplary embodiment of a pet food dispenser 20 according to the subject invention such that it is configured for controllable dispensation of a desired amount of pet food. Dispenser 20 includes flexible housing 24 and spout 22 having a resealable opening 21. Housing 24 may include one or more optional seams 26 where material used to form the housing has been joined together as described above. The seams of the housing may also include pleats. Closure 23, in the form of a cap, is also provided, shown in the unsealed position in FIG. 3A and the sealed position in FIG. 3B. Accordingly, closure 23 enables opening 21 to be repeatedly sealed and unsealed to dispense pet food from the dispenser.

Embodiments of the subject invention may incorporate the use of a gusseted housing (see for example gusset 28 of dispenser 20 shown in FIG. 3C). For definitional purposes, a gusseted housing is one having at least one gusseted side such as a gusseted base of the housing, which allows the gusseted dispenser to stand on the gusseted side, i.e., stand alone, without any external support, as shown standing on surface 100 in an upright position in FIG. 3D. Such provides certain advantages for efficient storing and dispensing as described above. In certain embodiments the dispensing end may be positioned in close proximity to the gusseted side. Accordingly, when positioned on the gusseted end, gravitational forces position pet food retained in the housing towards the gusseted side/dispensing end, and more specifically near the resealable opening, for efficient dispensing. For example, a gusseted housing may include two or more housing walls 27 and 29 that lay one on top of the other when the housing is not filled with pet food. A portion or region of the walls are connected together and closed to form the gusseted base as shown in FIG. 3C. The side edges of the walls may be joined or bonded directly to each other without the use of a gusset, as described above. The upper portion or region of the walls may be spread apart in order to fill the housing with pet food.

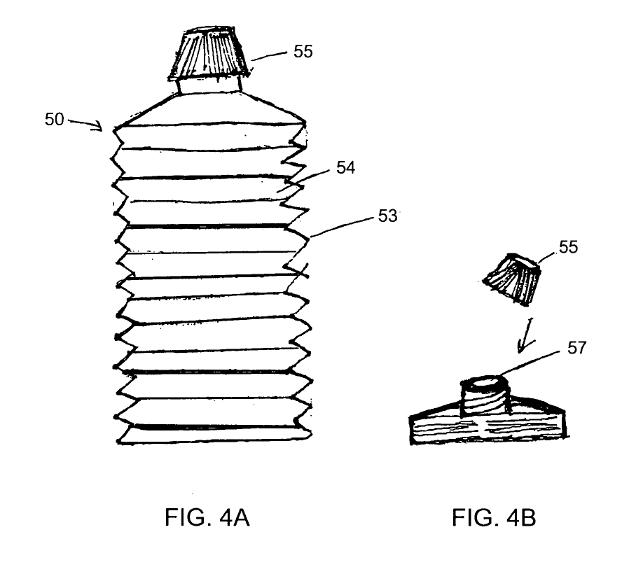

FIGS. 4A and 4B show another exemplary embodiment of a pet food dispenser 50 according to the subject invention such that it is configured for controllable dispensation of a desired amount of pet food. More specifically, FIG. 4A shown a front view of dispenser 50 in an expanded configuration, i.e., filled or substantially filled with pet food and FIG. 4B shown dispenser 50 in a compressed configuration, e.g., emptied of most or all of its contents of pet food. Dispenser 50 includes bellowed housing 54. In other words, the housing includes a bellows-type arrangement that facilitates dispensation of pet food from the dispenser. In certain embodiments, the position or directional movement or compression of the bellows may be indicative of a particular serving size, e.g., a single serving size such that compressing or collapsing the bellows a given amount as visually verified by the collapsed bellows, dispenses a given amount of pet food.

Dispenser 50 also includes resealable opening 57 coverable by cap 55. Accordingly, closure 55 enables opening 57 to be repeatedly sealed and unsealed to dispense pet food from the dispenser, i.e., is adapted to seal or rather re-seal opening 57 after dispensation of pet food from the dispenser.

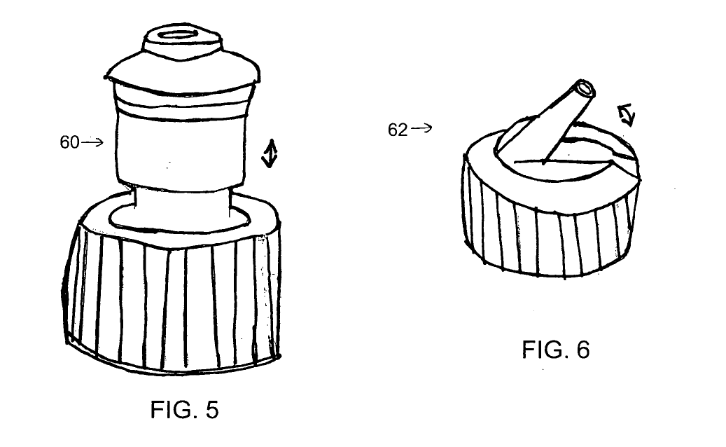

It is to be understood that resealable closure systems are not limited to the specific embodiments described herein. As noted above, a variety of different resealable closure systems are known and may be readily adaptable for use with the subject invention. For example, two other resealable systems that may be employed with the subject invention are shown in FIGS. 5 and 6. FIG. 5 shows an embodiment of a resealable push (seal)/pull (unseal) closure system 60 and FIG. 6 shows an embodiment of a resealable pop-up/push down closure system 62.

Utility

As described above, the subject pet food dispensing container may be use to dispense a variety of different pet foods for a variety of pets and other animals such as, but not limited to, cats, dogs, birds, rodents, reptiles, fish, amphibians, horses, cows, pigs, and the like and may be for domestic pets or livestock, e.g., household pets such as dogs, cats, etc. As noted above, the subject pet food dispensers are particularly well suited to dispense flowable pet foods or those pet foods having a viscosity that enables them to flow, e.g., be squeezed-out or extruded, of a subject dispenser upon application of a suitable force, if needed, to the dispenser. Such flowable pet foods generally have viscosities that fall within the ranges provided above.

In certain embodiments, the subject invention is used to dispense a controllable amount of flowable, nutritionally balanced cat food. Of particular interest are such cat foods that do not require refrigeration after being initially opened by a consumer, i.e., are shelf stable unrefrigerated, i.e., at ambient temperatures, after being opened by a consumer, for at least about 1 day to about 1 month or more. Once opened by a consumer, the pet food is typically used in a relatively short period of time. For example, where the dispensers retain about 42 ounces of such cat food (about 14 servings of about 3 ounce single servings), all the cat food would be dispensed from the dispenser in about one week if single servings were dispensed about two times a day.

Accordingly, the subject invention also includes nutritionally balanced, flowable cat foods that do not require refrigeration, even after the dispenser in which the cat food is contained has been opened one or more times, and which may be retained and controllably dispensed by the subject pet food dispensers. An advantage of this is that the pet food may be kept separate from human food stored in a refrigerator. Accordingly, undesirable confusion between human food and pet food may be avoided and contamination of human food stored in a refrigerator, such as physical contamination and/or odor contamination, may also be avoided.

The stability of the inventive cat foods is achieved by the combination of preservatives and processing parameters. For example, thoroughly mixed preservatives with the other components of the cat food to provide a homogenous mixture, combined with the high processing temperatures, effectively reduces the microbial content of the cat food to a safe, low level. For example, embodiments include cat food with a reduced bacterial contamination level of about one thousand per gram or less. Accordingly, once the microbial content is reduced to a pet-safe level, the system of preservatives of the cat food act to effectively maintain the stability of the cat food under ambient storage conditions, e.g., non-refrigerated conditions normally encountered at a warehouse, retail stored, pet owner's home, etc. (e.g., at temperatures that range from about 40° F. and 140° F.). The inventive cat foods are formulated so that it is not necessary to totally prevent recontamination of the cat food as features of the cat food are able to maintain microbial growth at levels that are safe for a cat. As such, the cat food may be repeatedly subject to the environment during dispensation of servings from a dispenser without spoiling or otherwise becoming unsafe for consumption.

A feature of the inventive nutritionally balanced, flowable cat foods is that they have a water activity which is not conducive for microbial growth. Accordingly, embodiments of the inventive ambient temperature stable cat foods a have a water activity (a_{w}) that ranges from about 0.9 to 0.95, e.g., from about 0.85 to about 0.9. The pH of the inventive cat foods generally ranges from about 4 to about 6, e.g., from about 4 to about 4.5, where such may be achieved with a suitable buffering (e.g., acidification) system if required.

The inventive cat foods also include one or more preservatives and antioxidants in effective or sufficient amount to prevent or at least retard microbial, e.g., mold, yeast, bacterial, growth at least to a degree that the cat food is suitable for pet consumption for at least about one day after the dispenser in which it is contained has first been opened and in many embodiments is stable for about 1 day to about 1 month or more, e.g., about 6 months or more, after opening. The cat foods may also include one or more antioxidants. Such preservatives and antioxidants include, but are not limited to, mixed tocopherols, tetra sodium EDTA, propyl paraben, methyl paraben, glycerin, sorbic acid, and its salts, BHT, BHA, vitamin E, rosemary extract, inorganic acids such as but not limited to phosphoric, hydrochloric, sulfuric, and organic acids such as but not limited to malic, fumaric, citric, proprionic, and the like and combinations thereof.

As noted above, the inventive cat foods are nutritionally balanced as defined by AAFCO Cat Food Nutrient Profiles (e.g., as published in the 2003 AAFCO Official Publication) or analogous authority. Accordingly, embodiments also include one or more vitamin/mineral components in effective or sufficient amount to provide the desired nutritional value. Vitamins components that may be included in the subject cat foods include, but are not limited to, Vitamin A, Vitamin D, alpha-tocopheryl acetate (Vitamin E), a source of Vitamin K activity such as niacin, thiamine (e.g., thiamine mononitrate as a source of B1), biotin, pyridoxine hydrochloride (B6), vitamin B12 supplement, riboflavin (B2), folic acid, choline chloride, pantothenic acid, ascorbic acid or esters of ascorbic acid, and the like, and combinations thereof. Mineral components that may be included in the subject cat foods include, but are not limited to various inorganic or organic sources of: zinc, iron, copper, manganese, sodium chloride, potassium, selenium, calcium, phosphorus, and the like, and combinations thereof.

Embodiments may also include an effective or sufficient amount of one or more amino acid components. Amino Acid components that may be included in the subject cat foods include, but are not limited to, L-alanine, glycine, lysine, DL-methionine, taurine, and the like, and combinations thereof.

An effective or sufficient amount of fat source may also be included. Source of fat may include, but are not limited to, safflower oil and/or other vegetable oils, oils from various fish, various types of beef fat, and poultry fat, and the like, and combinations thereof.

An effective or sufficient amount of one or more salts and/or binding agents may also be included in the subject cat foods and may include, but are not limited to, NaCl, phosphate salts, soluble gums such as but not limited to guar gum, xanthan gum, carrageenan gum, alginates, and the like, and combinations thereof.

The subject cat foods typically also include at least one or a combination of animal protein components including, but not limited to beef or other mammal sourced proteins, fish or shellfish sourced proteins, chicken or other poultry sourced proteins or egg based components. Accordingly, embodiments may include broth (poultry, beef or fish), fish, shellfish, beef (e.g., beef liver), poultry (e.g., chicken, turkey, etc.), egg (e.g., dried egg), and the like, and combinations thereof.

The subject cat foods may also include at least one or a combination of plant components including carbohydrate and protein sources including, but not limited to, corn, soy, wheat, rice and fractions thereof, modified food starches, wheat gluten, corn gluten, and the like, and combinations thereof. The subject cat foods typically also include at least one or a combination of sugars and or sugar based humectants including, but not limited to, dextrose, sucrose, fructose, glycerin, high fructose corn syrup, corn syrup, honey, molasses, fractions thereof, and the like, and combinations thereof.

For example, an exemplary embodiment of an ambient temperature stable cat food according to the subject invention may have a viscosity of about 80,000 cPs to about 1,000,000 cPs, e.g., about 800,000, a water activity of about 0.8 to about 0.95, e.g., about 0.9 and a pH of about 4 to about 6, e.g., about 4 to about 4.5, and include broth and at least one component such as fish, beef (e.g., beef liver), or poultry, in any suitable form. The cat food may also include some or all of: safflower oil, dried egg product, fish meal, sodium chloride, guar gum, potassium chloride, calcium carbonate, dried brewer's yeast, taurine, DL-methionine, tocopheryl acetate, zinc oxide, manganese sulfate, niacin, thiamin mononitrate, calcium pantothenate, biotin, pyridoxine hydrochloride, vitamin B12 supplement, riboflavin, folic acid, potassium iodide, menadione dimenthylpyrimidinol bisulfate, mixed tocopherols, tetra sodium EDTA, propyl paraben, methyl paraben, glycerin and sorbic acid. One or more coloring components may also be added such, but not limited to, as caramel coloring, sodium nitrite, and the like, and combinations thereof.

The inventive ambient temperature stable cat foods, e.g., the exemplary inventive cat food described above, may be prepared using any convenient techniques. For example, one way to make the inventive cat foods is to prepare a main blend and a vitamin/preservative blend separately, and then combine the blends together.

A main blend may be prepared by adding, to a main stainless steel jacketed cooking vessel (Vessel #1), appropriate broth (poultry, fish or beef, depending upon which flavor of food is to be produced). At least one fish, beef (e.g., beef liver), poultry, dried egg, and fish meal component may then be added to the broth and the contents heated to about 121° C.-177° C. (250° F.-350° F.) for about 30 minutes and then cooled to about 60° C.-93° C. (140° F. to 200° F.).

A vitamin/preservative blend may be prepared by charging a stainless steel cooking kettle (vessel #2) with glycerin, raising the temperature to about 38° C. -54° C. (100° F.-130° F.), adding sorbic acid and paraben's and stirring to dissolve the mixture. The heat may then be turned off and safflower oil, mixed tocopherols and remaining preservatives may be blended in and guar gum may be sifted in. The components are mix well. Vitamins and minerals may be mixed into this mixture until homogenous.

Once the two blends are prepared, they may be mixed together by transferring the contents of one of the vessels into the other and mixing very thoroughly at medium-low blender speed. At this point the pH may be checked and adjusted to achieve a final pH of about 4 to about 4.5. The final mixture may be blended by passing the mixture through an emulsifier or food mill until the mixture is uniform.

A subject pet food dispenser may then be filled with the uniform mixture of cat food using any convenient technique. For example, a subject device may be manually filled with cat food or filled using an automated system, e.g., a piston filler may be employed to fill the food directly into a subject device.

Prefilled Pet Food Dispensers

The subject invention also includes prefilled pet food dispensers. In other words, embodiments included subject pet food dispensers filled with an appropriate amount of flowable pet food, in many embodiments multiple servings of pet food, at a manufacturing site. The pet food dispensers prefilled with pet food may then be transported to a pet owner, e.g., first to a distribution center such as a pet store or the like, for purchase by a pet owner. In many embodiments, the subject dispensers are prefilled with pet food, e.g., filled through the resealable opening or other opened or yet unsealed or unclosed portion of the dispenser.

Embodiments include a subject pet food dispenser prefilled with one or more servings of ambient temperature stable pet food, e.g., ambient temperature stable cat food such as the inventive ambient temperature stable cat food described above.

Methods of Dispensing Flowable Pet Foods

The subject invention also includes methods of easily dispensing a controllable amount of pet food from a dispenser. Embodiments of the subject methods include applying slight to moderate amount of pressure, e.g., hand pressure, to a pet food dispenser containing pet food to controllably dispense a desired amount of pet food from the dispenser. By slight to moderate pressure is meant broadly to refer to an amount of pressure approximately commensurate with an amount of pressure that may be applied by hand or manually, to the dispenser.

Embodiments of the subject invention include methods for providing a food product to a recipient, the method including the steps of filling a flexible food container with a predetermined amount of the food product, releasabley sealing the flexible food container with a releasable closure, wherein the releasable closure inhibits spoilage of the food product, and wherein the method permits the flexible food container to be used for shipping, storing, selling and dispensing of pet food.

In practicing the subject methods, a pet food dispenser is filled with an amount of pet food, and in many embodiments if prefilled with an amount of pet food at a manufacturing site. The amount of pet food provided in a dispenser may vary depending on a variety of factors. For example, the number of servings that may be retained in a pet food dispenser at a given time, e.g., initially retained in a pet food dispenser (i.e., before any pet food is dispensed therefrom), may vary depending on the particular pet food retained, etc., where the number of pet food servings retained may range from about 1 to about 20 or more, e.g., from about 1 to about 14, e.g., from about 1 to about 7 such that embodiments include a total amount of flowable pet food initially retained or provided that may range from about 3 ounces to about 100 ounces or more. It is to be understood that more of less pet food (i.e., more or less servings and/or more of less weight) may be employed.

Accordingly, to controllably dispense a selected amount of pet food from a dispenser, the resealable closure is operatively disengaged from the resealable opening so that the opening is open to the environment and any tamper-evident feature is removed. The dispenser is suitably positioned to dispense the pet food, e.g., the resealable opening is positioned over a serving dish to which an amount of pet food is to be dispensed.

Controllably dispensing a selected amount such as a single serving of pet food from the dispenser may be accomplished in any convenient manner and may be dictated at least in part by the particular pet food to be dispensed, the particular configuration of the dispenser, etc. In general, for flowable pet food that is not in a highly liquid form, slight to moderate amount of hand pressure may be applied to the dispenser to compress at least a portion of the dispenser to expel (e.g., squeeze) a controllable amount of pet food out of the resealable opening. In those embodiments having a dispenser that includes a bellowed housing, controllably dispensing a selected amount of pet food from the dispenser may include actuating (e.g., collapsing or contracting) at least a portion of the bellowed housing to expel a selected amount of flowable pet food from the opening of the housing.

However, it may not always be necessary to apply pressure to the dispenser to expel a desired quantity of pet food, where the viscosity of the pet food will typically dictate at least in part whether hand pressure is necessary. For example, highly viscous pet food, including highly liquid pet food, may or may not include application of pressure to dispense the pet food. For example, the flowable pet food may be in a form that has sufficient viscosity to enable it to be controllably dispensed from a dispenser by simply opening the opening of the housing and expelling, e.g., pouring, out a desired amount therefrom. The amount of pet food dispensed may be controlled in a variety of ways, including, but not limited to, degree and/or length of time of pressure application and/or the positioning of the dispenser and/or gentle agitation or shaking of the dispenser, and the like.

Once the desired quantity of pet food has been expelled from the dispenser, the resealable opening may then be resealed so that any pet food remaining in the dispenser may be dispensed at a later time.

Embodiments of the subject methods include retaining and controllably dispensing a desired amount of an ambient temperature stable pet food such as an ambient temperature stable cat food, as described above. Accordingly such embodiments include storing the pet food unrefrigerated before and after use such that the dispenser/pet food need not be refrigerated and yet remains stable.

It is evident from the above discussion that the above described invention provides pet food dispensers and methods of dispensing pet food that are easy and efficient to use and are applicable to a wide variety of pet foods. Embodiments also include pet foods that do not require refrigeration upon opening. As such, the subject invention represents a significant contribution to the art.

All publications and patent applications cited in this specification are herein incorporated by reference as if each individual publication or patent application were specifically and individually indicated to be incorporated by reference. The citation of any publication is for its disclosure prior to the filing date and should not be construed as an admission that the present invention is not entitled to antedate such publication by virtue of prior invention.

Although the foregoing invention has been described in some detail by way of illustration and example for purposes of clarity of understanding, it is readily apparent to those of ordinary skill in the art in light of the teachings of this invention that certain changes and modifications may be made thereto without departing from the spirit or scope of the appended claims.

What is claimed is:

1. A resealable pet food dispenser, said dispenser comprising a housing and a resealable opening therein, said housing configured for retaining and controllably dispensing a selected amount of flowable pet food through said resealable opening.

2. The resealable pet food dispenser of claim 1, wherein at least a portion of said housing is flexible.

3. The resealable pet food dispenser of claim 1, wherein said housing is a bellowed housing.

4. The resealable pet food dispenser of claim 1, wherein said housing is a gusseted housing.

5. The resealable pet food dispenser of claim 1, wherein said dispenser has a volume that ranges from about 50 milliliters to about 2000 milliliters.

6. The resealable pet food dispenser of claim 1, wherein said dispenser comprises at least one surface upon which said dispenser can stand on end in an upright position without any external support.

7. The resealable pet food dispenser of claim 1, further comprising a closure member positioned about said opening for sealing and unsealing said resealable opening.

8. The resealable pet food dispenser of claim 7, wherein said closure comprises a base member and a cap member.

9. The resealable pet food dispenser of claim 8, wherein said base member and said cap member are operatively connected to each other with a hinge member.

10. The resealable pet food dispenser of claim 7, wherein said closure comprises a screw cap comprising threads.

11. The resealable pet food dispenser of claim 1, wherein said housing is fabricated from at least one of: metals and alloys thereof, polypropylene, polyethylene, high density polyethylene, low density polyethylene, and linear low density polyethylenes, polystyrene, high impact polystyrene, polytetrafluoro-ethylene, polypropylene, poly (4-methylbutene), polystyrene, poly(ethylene terephthalate), polyolefin, polycarbonate, polyacrylamide, polyacrylate, polymethacrylate, polyesters, PVC, PVC blends, nylon and paperboard, and combinations thereof.

12. The resealable pet food dispenser of claim 1, wherein said opening comprises a spout.

13. The resealable pet food dispenser of claim 1, wherein said opening ranges from about ¼ inch to about 1 inch in diameter.

14. A pet food dispenser comprising:
a flexible food container having joined walls and defining a food discharge opening;
a closure attachment region surrounding said food discharge opening; and
a releasable closure on said flexible food container for opening and closing said food discharge opening, said releasable closure including a base member and a cap member, wherein said base member operatively engages said closure attachment region and wherein said cap member seals said discharge opening and permits the container to be used for shipping, storing, selling and dispensing of food product.

15. A prefilled pet food dispenser, said prefilled pet food dispenser comprising:
(a) a housing and a resealable opening therein, said housing configured for retaining and controllably dispensing a selected amount of flowable pet food through said resealable opening; and
(b) an amount of nutritionally balanced flowable pet food retained therein.

16. The prefilled pet food dispenser of claim 15, wherein said flowable pet food has a viscosity that ranges from about 80,000 cPs to about 1,000,000 cPs.

17. The prefilled pet food dispenser of claim 15, wherein said flowable pet food has water activity that ranges from about 0.8 to about 0.95.

18. The prefilled pet food dispenser of claim 15, wherein said flowable pet food is an ambient temperature stable flowable pet food.

19. The prefilled pet food dispenser of claim 18, wherein said ambient temperature stable flowable pet food is stable at ambient temperatures for at least about 1 day to about 1 month after opening.

20. The prefilled pet food dispenser of claim 19, wherein said ambient temperature stable flowable pet food is ambient temperature stable flowable cat food.

21. The prefilled pet food dispenser of claim 15, wherein said dispenser is prefilled with a plurality of single servings of pet food.

22. A Nutritionally balanced, ambient temperature stable flowable pet food, said nutritionally balanced ambient temperature stable pet food comprising:
(a) a broth component,
(b) at least one beef, poultry, fish or egg component, and
(c) a preservative and antioxidant system effective to stably maintain said nutritionally balanced ambient temperature stable pet food at ambient temperatures for at least about 1 day to about 1 month after opening.

23. The nutritionally balanced ambient temperature stable pet food of claim 22, wherein said preservative and antioxidant system comprises at least one of: mixed tocopherols, tetra sodium EDTA, propyl paraben, methyl paraben, glycerin, sorbic acid, and its salts, BHT, BHA, vitamin E, rosemary extract, citric acid, inorganic acid, organic acid and combinations thereof.

24. The nutritionally balanced ambient temperature stable pet food of claim 23, wherein said preservative and antioxidant system comprises each of: mixed tocopherols, tetra sodium EDTA, propyl paraben, methyl paraben, glycerin, sorbic acid, and its salts, BHT, BHA, vitamin E, rosemary extract, citric acid, inorganic acid and organic acid.

25. The nutritionally balanced ambient temperature stable pet food of claim 22, further comprising a vitamin component.

26. The nutritionally balanced ambient temperature stable pet food of claim 22, further comprising an amino acid component.

27. The nutritionally balanced ambient temperature stable pet food of claim 22, further comprising a fat component.

28. The nutritionally balanced ambient temperature stable pet food of claim 22, wherein said nutritionally balanced ambient temperature stable pet food has a pH that ranges from about 4 to about 6.

29. The nutritionally balanced ambient temperature stable pet food of claim 22, wherein said nutritionally balanced ambient temperature stable pet food has a viscosity that ranges from about 80,000 cPs to about cPs.

30. The nutritionally balanced ambient temperature stable pet food of claim 22, wherein said nutritionally balanced ambient temperature stable pet food has a water activity that ranges from about 0.8 to about 0.95.

31. The nutritionally balanced ambient temperature stable pet food of claim 22, wherein said nutritionally balanced ambient temperature stable pet food is nutritionally balanced ambient temperature stable cat food.

32. A method of retaining and dispensing a controllable amount of flowable pet food, said method comprising:
(a) retaining an amount of flowable pet food in a resealable pet food dispenser comprising a housing and a resealable opening therein, and
(b) controllably dispensing a selected amount of flowable pet food through said resealable opening.

33. The method of claim 32, wherein said controllably dispensing comprises applying pressure to said housing.

33. The method of claim 32, wherein said housing is a bellowed housing and said controllably dispensing comprises collapsing at least a portion of said bellowed housing.

34. The method of claim 32, wherein said flowable pet food is nutritionally balanced, ambient temperature stable pet food.

35. The method of claim 34, wherein said flowable pet food is cat food.

36. A method for providing a food product to a recipient, said method comprising the steps of:
filling a flexible food container with a predetermined amount of said food product; and
releasably sealing said flexible food container with releasable closure, wherein said releasable closure inhibits spoilage of said food product; and
wherein said method permits said flexible food container to be used for shipping, storing, selling and dispensing of pet food.
